(19) United States
(12) Patent Application Publication
(10) Pub. No.: US 2010/0220910 A1
(43) Pub. Date: Sep. 2, 2010

(54) METHOD AND SYSTEM FOR AUTOMATED X-RAY INSPECTION OF OBJECTS

(75) Inventors: Robert August Kaucic, Niskayuna, NY (US); James Vradenburg Miller, Clifton Park, NY (US); Ali Can, Troy, NY (US); Zhaohui Sun, Niskayuna, NY (US); Xiaodong Tao, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/395,761

(22) Filed: Mar. 2, 2009

(51) Int. Cl. G06K 9/00

(52) U.S. Cl. 382/131; 382/154

(57) ABSTRACT

An anomaly detection method and system for comparing a scanned object to an idealized object is provided. The anomaly detection method includes generating a three-dimensional reference model of the idealized object. The anomaly detection method further includes acquiring at least one two-dimensional inspection test image of the scanned object. The anamoly detection method also includes determining a two-dimensional reference image from the three-dimensional reference model using multiple pose parameters, wherein the two-dimensional reference image corresponds to the same view of the three-dimensional reference model of the idealized object as the view of the two-dimensional inspection test image of the scanned object. The anamoly detection method further includes identifying one or more defects in the inspection test image via automated defect recognition technique.

### BACKGROUND

The invention relates generally to nondestructive testing (NDT) of parts and more particularly to a method and system for automatically identifying defects in NDT image data corresponding to a scanned object.

NDT is a technique of producing relevant data for an object by collecting energy emitted by or transmitted through the object, such as by penetrating radiation (gamma rays, X-rays, neutrons, charged particles, etc.) sound waves, or light (infrared, ultraviolet, visible, etc.). The manner by which energy is transmitted through or emitted by any object depends upon variations in object thickness, density, and chemical composition. The energy emergent from the object is collected by appropriate detectors to form an image or object map, which may then be realized on an image detection medium, such as a radiation sensitive detector. A radiographic detector, for example, comprises an array of elements that records the incident energy at each element position, and maps the recording onto a two-dimensional (2D) image. The 2D image is then fed to a computer workstation and interpreted by trained personnel. Non-limiting examples of NDT modalities include X-ray, CT, infrared, eddy current, ultrasound and optical.

Radiography and other NDT inspection modalities find wide application in various medical and industrial applications as a non-destructive technique for examining the internal structure of an object. Non-destructive evaluation (NDE) of industrial parts is essential for manufacturing productivity and quality control. For example, in aerospace and automotive industries, radiographic images of aluminum castings are typically inspected by an operator who identifies defects pertaining to porosities, inclusions, shrinkages, cracks, etc. in the castings. However, and as will be appreciated by those skilled in the art, owing to the structural complexity and large production volumes of these castings, the manual inspection procedure is often prone to operator fatigue and hence suffers from low inspection reliability.

A number of NDT inspection techniques such as feature-based classification, artificial neural networks and adaptive filtering have been developed to perform automatic radiographic inspections of scanned objects. These techniques are typically based on using automated defect recognition (ADR) techniques to automatically screen images, call out defects and prioritize the ones needing visual inspection. As will be appreciated by those skilled in the art, ADR techniques typically achieve more accurate defect detection than human operators and have a much higher efficiency and consistency, thereby enhancing quality control in a wide variety of applications, such as, for example, automotive parts and engine components of aircraft, ships and power generators. Techniques using ADR may typically be used to perform automatic defect detection on 2D images and/or 3D images, based on analyzing the geometry (e.g., shape, size), feature (e.g., intensity, texture, color) and other local image statistics in the radiographic image data, to locate abnormalities. For example, ADR techniques based on image features use a set of features to identify potential flaws in scanned object parts based on flaw morphology and gray level statistics. These techniques assign each pixel in the image into one of several classes based on minimizing a distance metric, wherein the parameters characterizing the distance metric are evaluated using a supervised learning scheme. However, the performance of these techniques is affected by variations caused by object structure or flaw morphology and these techniques generally require large training sets with labeled flaws to perform defect identification. Additionally, a number of NDT techniques involving 3D scanning of objects and 3D image to 2D image registration, makes the process of anomaly detection slower and inefficient.

It would therefore be desirable to develop an efficient NDT inspection technique for automatically detecting defects in the NDT image data corresponding to a scanned object. In addition, it would be desirable to develop an efficient NDT inspection technique that detects anomalies in industrial parts, produces accurate defect detection rates, increases the screening efficiency and consistency of inspection systems, efficiently utilizes system operation setup time and system training time and is robust to changes in object part geometry and misalignment of scanned object parts.

### BRIEF DESCRIPTION

In accordance with an embodiment of the invention, an anomaly detection method for comparing a scanned object to an idealized object is provided. The anomaly detection method includes generating a three-dimensional reference model of the idealized object. The anomaly detection method further includes acquiring at least one two-dimensional inspection test image of the scanned object and determining a two-dimensional reference image from the three-dimensional reference model using multiple pose parameters estimated by a 3D-2D registration algorithm, wherein the two-dimensional reference image corresponds to the same view of the three-dimensional reference model of the idealized object as the view of the two-dimensional inspection test image of the scanned object. Finally, the anomaly detection method includes identifying one or more defects in the inspection test image via automated defect recognition technique.

In accordance with another embodiment of the invention, an inspection system is provided. The inspection system includes an imaging system configured to acquire inspection test image data corresponding to a scanned object. The inspection system further includes a computer system configured to be in signal communication with the imaging system. The computer system comprises a memory configured to store the inspection test image data corresponding to the scanned object, wherein the image data comprises at least one of an inspection test image of the scanned object and one or more reference images for the idealized object. The computer system further includes a processor configured to process the inspection test image data corresponding to the object. The processor is further configured to generate a three-dimensional reference model of the idealized object, receive the inspection test image data of the scanned object from the imaging system, determine a two-dimensional reference image from the three-dimensional reference model using multiple pose parameters estimated by a 3D-2D registration algorithm, and identify one or more defects in the inspection test image via automated defect recognition technique. The inspection system further includes a display device configured to display one or more defects in the inspection test image data corresponding to the scanned object.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of an exemplary inspection system for automated X-ray inspection of three-dimensional objects.

FIG. 2 is a flowchart illustrating an exemplary process for anomaly detection in accordance with aspects of the present technique.

FIG. 3 depicts a schematic block diagram for generating a three-dimensional reference model.

### DETAILED DESCRIPTION

The present techniques are generally directed to automated anomaly detection, possibly in conjunction with computer assisted detection and/or diagnosis (CAD) algorithms. Such analysis may be useful in a variety of imaging contexts, such as industrial inspection system, nondestructive testing and others.

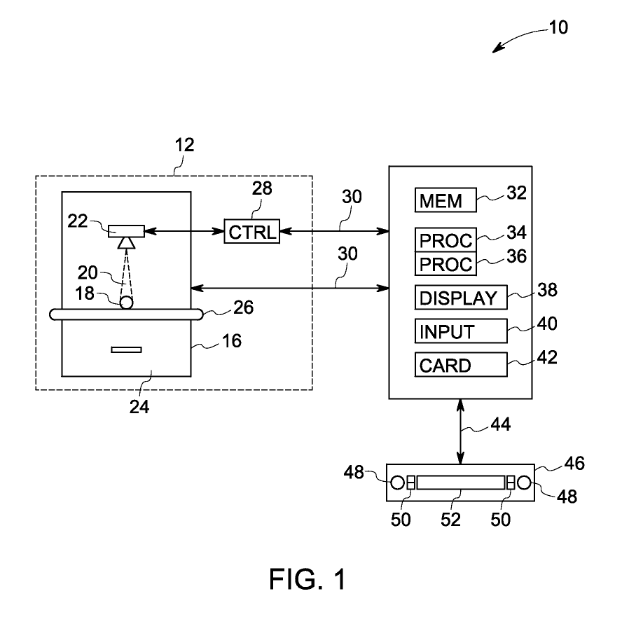

FIG. 1 is an illustration of an exemplary inspection system for processing an inspection test image data corresponding to a scanned object. It should be noted that although the illustrated example is directed to automated anomaly detection using x-ray inspection, the present invention is equally applicable to other inspection modalities, non-limiting examples of which include CT, infrared, eddy current, ultrasound and optical. Referring to FIG. 1, the inspection system 10 includes a computer system 14 adapted to be in signal communication with an imaging system 12 via a communication bus 30. A real-time image controller 46 is adapted to be in signal communication with the computer system 14 via another communication bus 44. The imaging system 12 is configured to acquire and output x-ray image data corresponding to a scanned object 18 via an imaging device 16. The imaging system 12 may include, but is not limited to, an X-ray system, a CT system, an infra-red system, an eddy current system, an ultrasound system and an optical system. In one embodiment, the imaging device 16 includes an X-ray source 22, an image detector 24 and an object manipulator 26. The imaging system 12 also includes an imaging system controller 28 that receives control commands from the computer system 14 and sends control signals to the various components of the imaging device 16. The object manipulator 26 may be a conveyor belt, a reversible table, or any other suitable device for manipulating the scanned object 18 into and out of the X-ray beam 20.

The computer system 14 includes a memory 32 configured to store the X-ray inspection test image data corresponding to the scanned object 18. Further, the memory 32 may include, but is not limited to, any type and number of memory chip, magnetic storage disks, optical storage disks, mass storage devices, or any other storage device suitable for retaining information. The computer system 14 also includes one or more processors 34, 36 configured to process the X-ray inspection test image data corresponding to the scanned object.

It should be noted that embodiments of the invention are not limited to any particular processor for performing the processing tasks of the invention. The term “processor,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of the invention, as will be understood by those skilled in the art.

In one embodiment, and as will be described in greater detail below, the processor is further configured to generate a three-dimensional reference model of the idealized object. The processor further receives the inspection test image data of the scanned object from the imaging system and determines a two-dimensional reference image from the three-dimensional reference model using multiple pose parameters estimated by a 3D-2D registration algorithm, wherein the two-dimensional reference image corresponds to the same view of the three-dimensional reference model of the idealized object as the view of the two-dimensional inspection test image of the scanned object. Furthermore, the processor registers the three-dimensional reference model and the two-dimensional inspection test image of the scanned object and identifies one or more defects in the inspection test image via an automated defect recognition technique. Various automated defect recognition (ADR) techniques, well known to one skilled in the art, may be employed. In one ADR embodiment, the reference model consists of a 3D statistical model of both part density and part variation. Defects are found by statistically testing the 2D test image against both the registered and projected 2D reference image and labeling areas as defects that fall outside of normalcy probabilities. Further details of the automated defect recognition technique may be obtained in U.S. Pat. No. 4,896,278 entitled “AUTOMATED DEFECT RECOGNITION SYSTEM”, the entirety of which is hereby incorporated by reference herein.

The computer system 14 also includes a detector interface card 42, an input device 40 and a display device 38. The input device 40 may include, but is not limited to, a keyboard, a mouse, a pointing device, a touch sensitive screen device, a tablet, a read/write drive for a magnetic disk, a read/write drive for an optical disk, a read/write drive for any other input medium, an input port for a communication link (electrical or optical), a wireless receiver. The display device 38 may be a CRT (cathode ray tube) screen or any other suitable display device for displaying text, graphics and a graphical user interface, for example. In one embodiment, the display device is configured to display one or more defects in the X-ray inspection test image corresponding to the scanned object. The input device 40 and the display device 38 operate in combination to provide a graphical user interface, which enables a user or operator to configure and operate the radiographic inspection system 10. The detector interface card 42 provides low-level control over the image detector, buffers data read out from the image detector 24, and optionally reorders image pixels to convert from read-out order to display order. The real-time image controller 46 includes a set of image control buttons 50, a set of image control dials 48, a display 52, and an embedded application programming interface that maps the functions of the control buttons and dials 48, 50 to the computer system 14.

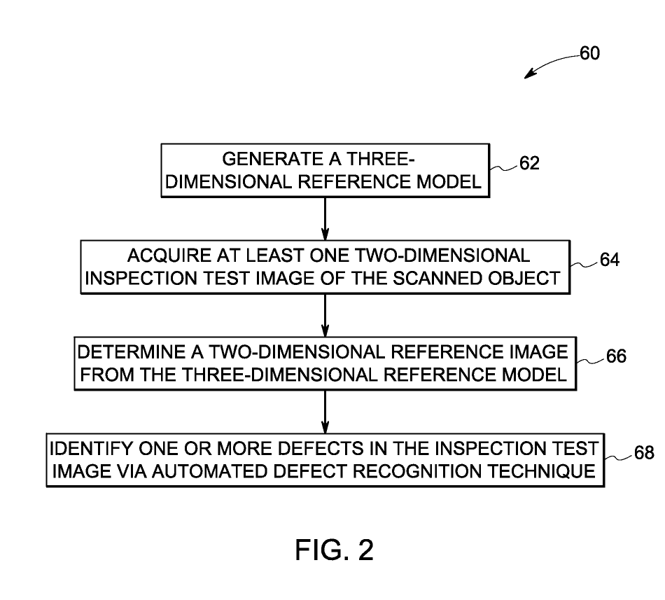

FIG. 2 illustrates a flowchart of an exemplary process 60 for anomaly detection of a scanned object through comparative analysis of the X-ray inspection test image to an idealized object. For certain applications, the defects may include, but are not limited to, casting and/or manufacturing defects present in a scanned object. Further, in certain applications, the scanned object may include industrial parts, such as, for example, turbine engine components. The scanned object may also include, automotive parts such as, casting wheels, engine components, and shafts. Other non-limiting exemplary applications of the present anomaly detection process 60 may be in the manufacture of aircraft engine parts. During manufacturing of aircraft engine parts, variations are inevitable due to slight variations in the casting and processing steps. Such variations or anomalies are efficiently captured by the techniques of the present invention, which are described in one or more specific embodiments below. Referring to FIG. 2, now, the process 60 comprises generating a three-dimensional reference model of the idealized object at step 62. In the present context, the idealized object may be referred to a defect free object or defect free objects having variations in geometric shape or a three-dimensional CAD model of a virtual defect free object. In step 64, a two-dimensional inspection test image data corresponding to a scanned object is acquired. The inspection test image data comprises an X-ray image data and is acquired using an inspection system as described in FIG. 1. Other examples of inspection image data include, without limitation, radiography, CT, infrared, eddy current, ultrasound and optical image data. In step 66, multiple pose parameters are estimated by a 3D-2D registration algorithm to generate a two-dimensional reference image from the three-dimensional reference model. The multiple pose parameters may include rotational or translational parameters to incorporate any rotational or translational orientation of the scanned object to generate a two-dimensional reference image from the three-dimensional reference model.

Additionally, in one embodiment, the two-dimensional reference image is determined by forward projection of the three-dimensional reference model. In another embodiment, the two-dimensional reference image is determined by simulation of x-ray imagine of the three-dimensional reference model.

In yet another embodiment, the two-dimensional reference image is registered to the two-dimensional inspection test image of the scanned object. The registration is performed so as to address the differences in the acquisition parameters between different imaging modalities. The process of registration, which is also referred to as image fusion, superimposition, matching or merging, maps each point in one image onto the corresponding point in the second image. As will be appreciated by those skilled in the art, any registration method may be employed to register the images with one another before comparing the images for differences or changes. This includes fully automatic registration as well as computer assisted manual registration, or any registration approach using varying degrees of manual intervention.

Finally, at step 68, one or more defects in the inspection test image are identified via automatic defect recognition technique, which may comprise statistical evaluation, image differencing from a reference image, or pattern recognition for performing two-dimensional detection.

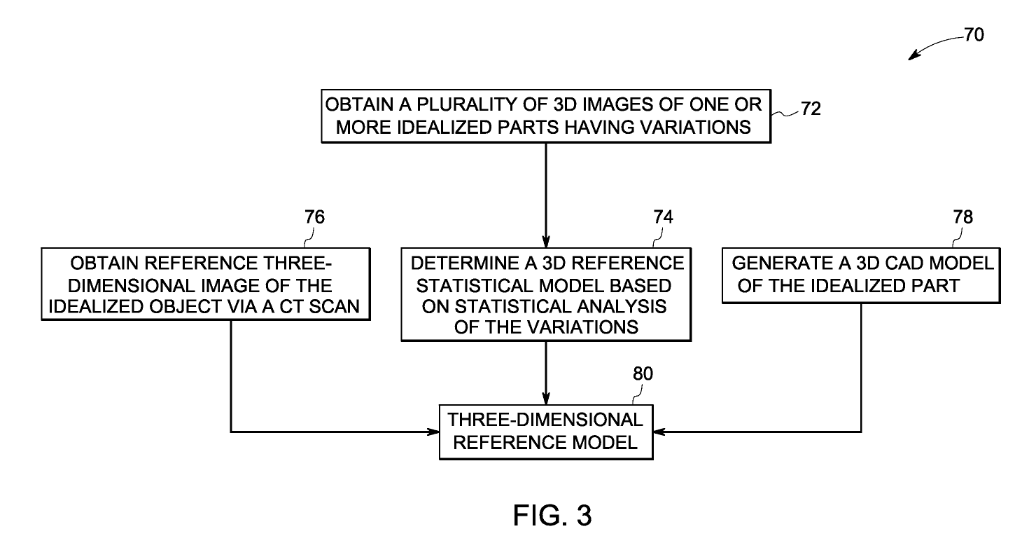

FIG. 3 is a schematic block diagram 70 illustrating a specific embodiment for performing step 62 in FIG. 2 to generate a three-dimensional reference model 80. In one embodiment as represented in block 76, the three-dimensional reference model 80 is generated from at least one reference three-dimensional image of the idealized object obtained via a computer tomography scan of a physical representation of the idealized object. In another embodiment, the three-dimensional reference model is determined from a three-dimensional statistical reference model based on a statistical analysis of variations between multiple three-dimensional images of one or more physical representations of the idealized object, which is sufficiently highlighted in subsequent blocks 72 and 74. Thus, the present invention sufficiently represents pre-processing of the part variations in 3D using a 3D statistical reference image and pre-processing of the manufacturing defects in 2D by comparing the 2D inspection test image to the projected or computed 2D reference image. In yet another embodiment, the three-dimensional reference model is determined from a three-dimensional CAD model 78 of the idealized object.

Embodiments of the present invention disclose a modeling technique to identify anomalies in inspection test image data corresponding to a scanned object, by generating a three-dimensional reference model and using 3D-2D registration and projection algorithms to determine a two-dimensional reference image to be compared to the inspection test image and applying the standard ADR techniques. The disclosed anomaly detection approach efficiently utilizes the system operation time by eliminating the steps of aligning the objects such as metal castings to be scanned in an assembly line.

Advantageously, the three-dimensional reference modeling approach is robust to changes in object part geometry and misalignment of scanned object parts since it is built using a number of defect-free images that can automatically encode normal variations that occur due to part-to-part variations within manufacturing specifications and image-to-image variations that occur due to appearance changes and spatial misalignment. Further, the present invention increases screening efficiency and consistency of inspection systems. In addition, the disclosed statistical modeling approach for detecting defects may be applied to multiple observations corresponding to multiple images of the scanned object acquired at one or more view angles.

The various embodiments of the anomaly detection method and inspection system described above thus provide a way to achieve a convenient and efficient automatic identification of defects in NDT image data corresponding to a scanned object.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An anomaly detection method for comparing a scanned object to an idealized object, the method comprising:
generating a three-dimensional reference model of the idealized object;
acquiring at least one two-dimensional inspection test image of the scanned object;
determining a two-dimensional reference image from the three-dimensional reference model using a plurality of pose parameters, wherein the two-dimensional reference image of the three-dimensional reference model of the idealized object corresponds to the same view as the two-dimensional inspection test image of the scanned object; and
identifying one or more defects in the inspection test image via automated defect recognition technique.

2. The method of claim 1, wherein generating the three-dimensional reference model comprises obtaining at least one reference three-dimensional image of the idealized object via a computer tomography scan of a physical representation of the idealized object.

3. The method of claim 1, wherein generating the three-dimensional reference model comprises determining a three-dimensional statistical reference model based on a statistical analysis of variations between a plurality of three-dimensional images of one or more physical representations of the idealized object.

4. The method of claim 1, wherein generating the three-dimensional reference model further comprises determining a three-dimensional CAD model of said idealized object.

5. The method of claim 1, wherein the two-dimensional reference image is determined by forward projection of the three-dimensional reference model.

6. The method of claim 1, wherein the two-dimensional reference image is determined by simulation of x-ray imagine of the three-dimensional reference model.

7. The method of claim 1, wherein the automated defect recognition technique comprises statistical evaluation, image differencing from a reference image, or pattern recognition for performing two-dimensional detection.

8. The method of claim 1, wherein the plurality of pose parameters are estimated by a 3D-2D registration algorithm.

9. An inspection system comprising:
an imaging system configured to acquire inspection test image data corresponding to a scanned object; and
a computer system configured to be in signal communication with the imaging system, wherein the computer system comprises:
a memory configured to store the inspection test image data corresponding to the scanned object, wherein the image data comprises at least one of an inspection test image of the scanned object and one or more reference images for the idealized object;
a processor configured to process the inspection test image data corresponding to the object, wherein the processor is further configured to:
generate a three-dimensional reference model of the idealized object;
receive the inspection test image data of the scanned object from the imaging system;
determine a two-dimensional reference image from the three-dimensional reference model using a plurality of pose parameters, wherein the two-dimensional reference image of the three-dimensional reference model of the idealized object corresponds to the same view as the two-dimensional inspection test image of the scanned object; and
identify one or more defects in the inspection test image via automated defect recognition technique; and
a display device configured to display the one or more defects in the inspection test image data corresponding to the scanned object.

10. The system of claim 9, wherein the processor is further configured to generate the three-dimensional reference model by obtaining at least one reference three-dimensional image of the idealized object via a computer tomography scan of a physical representation of the idealized object.

11. The system of claim 9, wherein the processor is further configured to generate the three-dimensional reference model by determining a three-dimensional statistical reference model based on a statistical analysis of the variations between a plurality of three-dimensional images of one or more physical representations of the idealized object

12. The system of claim 9, wherein the processor is further configured to generate the three-dimensional reference model by determining a three-dimensional CAD model of the idealized object.

13. The system of claim 9, wherein the scanned object comprises a metal casting.

14. The system of claim 9, wherein the imaging system comprises an X-ray source, an image detector, an object manipulator, an imaging system controller that receives control commands from the computer system and sends control signals to the various components of the imaging system.

15. The system of claim 9, wherein the imaging system is selected from the group consisting of: an X-ray system, a CT system, an infrared system, an eddy current system, an ultrasound system and an optical system.
